(19) United States
(12) Patent Application Publication
(10) Pub. No.: US 2024/0035666 A1
(43) Pub. Date: Feb. 1, 2024

(54) Food Cooking Appliance For Cooking A Food Product Disposed On A Substrate

(71) Applicant: JK Burnersystems, LLC, Las Vegas, NV (US)

(72) Inventors: Juergen Koch, Las Vegas, NV (US); Matthias Mueller, Olpe (DE)

(73) Assignee: JK Burnersystems, LLC, Las Vegas (US)

(21) Appl. No.: 18/344,093

(22) Filed: Jun. 29, 2023

Related U.S. Application Data
(60) Provisional application No. 63/392,220, filed on Jul. 26, 2022.

(51) Int. Cl. F24C 3/00; F24C 3/08; A47J 37/04

(52) U.S. Cl. CPC F24C 3/008; F24C 3/085; A47J 37/041

(57) ABSTRACT

A food cooking appliance for cooking a food product disposed on a substrate is disclosed. The food cooking appliance comprises a gas burner disposed below the substrate. The gas burner includes a plurality of circumferentially spaced flame openings and a radiant disposed above and proximate to the spaced flame openings. Heat generated by flames emanating from the spaced flame openings heats the radiant, causing the radiant to radiate heat, to increase the overall heat transferred to the substrate by the burner.

### BACKGROUND

Gas burners, such as for commercial food cooking appliances, are known. Such burners may burn gas, such as natural gas, LP gas or the like.

Such gas burners may be used in conjunction with a food cooking appliance, such as a commercial hamburger grill for sequentially cooking hamburger patties. The food cooking appliance may be a hamburger grill having a moving substrate, such as a rotary platter, onto which uncooked hamburger patties, or similar food products, may be loaded. As the substrate moves, the hamburger patties may progressively pass one or more burners which may sequentially cook the hamburgers, after which the cooked hamburgers may be removed.

It is desirable to cook the hamburgers as quickly and efficiently as possible, while maintaining desired quality.

The present invention is provided to address this and other problems.

### SUMMARY

It is an object of the present invention to provide gas burners for a rotary grill which may cooperatively direct an appropriate amount of heat onto upper and lower surfaces of sequentially passing hamburger patties.

This and other objectives and advantages may become apparent from the following description taken in conjunction with the accompanying Figures.

### DESCRIPTION OF THE FIGURES

FIG. 1 is a plan view of a rotary grill incorporating first and second gas burners in accordance with the present invention;

FIG. 2 is a perspective view of the first burner of FIG. 1;

FIG. 3 is a first side view of the first burner of FIG. 1;

FIG. 4 is a second side view of the first burner of FIG. 1;

FIG. 5 is a plan view of the second burner of FIG. 1;

FIG. 6 is a perspective view of the second burner of FIG. 1; and

FIG. 7 is a front view of the second burner of FIG. 1.

### DESCRIPTION OF THE PREFERRED EMBODIMENT

While this invention is susceptible of embodiments in many different forms, there will be described herein in detail, specific embodiments thereof, with an understanding that the present disclosure is to be considered an exemplification of the principles of the invention and is not intended to limit the invention to the specific embodiments illustrated.

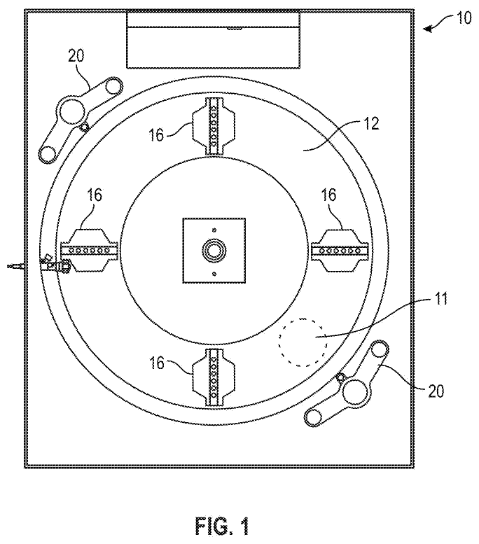

A grill, generally designated 10, such as for sequentially cooking a plurality of hamburger patties 11 (one shown), is illustrated in FIG. 1. The grill 10 may include a moving substrate, such as a rotary platter 12, which rotary platter may rotate, such as by an electric motor (not shown). The grill 10 may include a first gas burner 16 adapted to cook the underside of passing hamburger patties 11, and a second gas burner 20 adapted to cook the topside of passing hamburger patties 11.

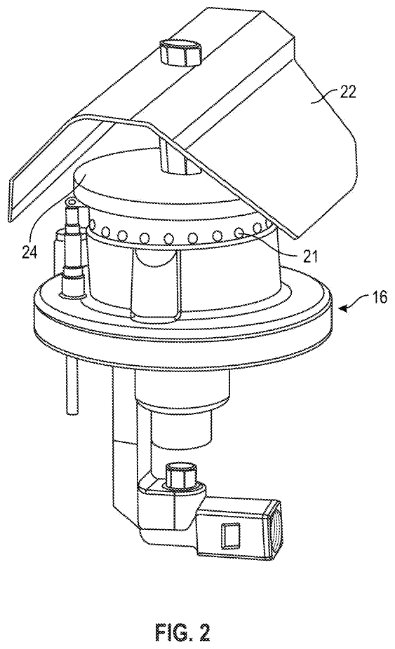

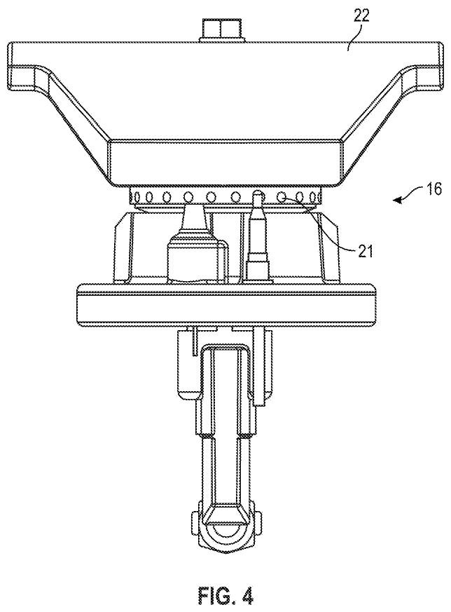

One embodiment of the first burner 16 is illustrated in greater detail in FIGS. 2-4. The first burner may be disposed below the rotary platter 12, and thus below ones of the hamburger patties passing thereover. The first burner 16 may be a generally conventional gas burner, such as one having a 6000 BTU heat output, which may provide a flame from a plurality of circumferentially spaced flame openings 21. The first burner 16 may also include a heating element, or radiant, 22, disposed above, and proximate to, the flame openings. The radiant 22 may be made of cast iron, such as grade GG18 cast iron, or such other suitable material. The radiant 22 may itself be heated by flames emanating from the first burner 16, and the radiant 22 may in turn radiate additional heat, such as in the form of infra-red heat energy. Heat from the first burner 16, including the heat radiated by the radiant 22, may provide heat of the order of 350° C., to the passing hamburger patties 11, to properly assist in the cooking of the passing hamburger patties 11 from the underside of the passing hamburger patties 11.

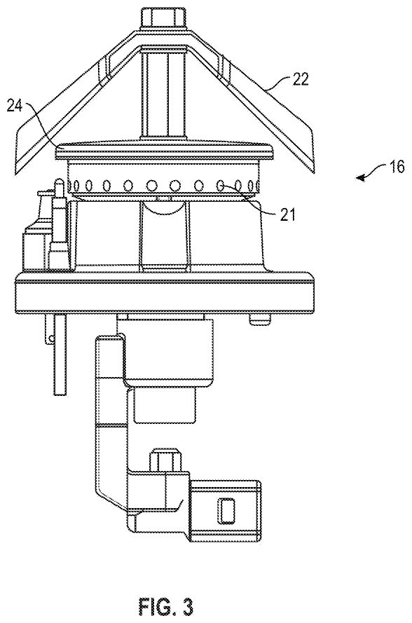

The first burner 16 is shown in FIGS. 2 and 3 with a top cap 24, although such top cap 24 is generally not considered necessary.

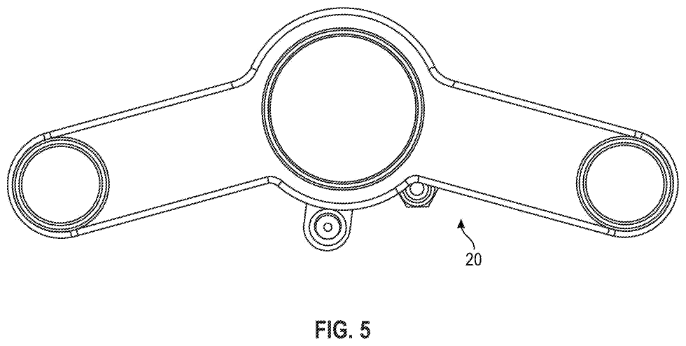

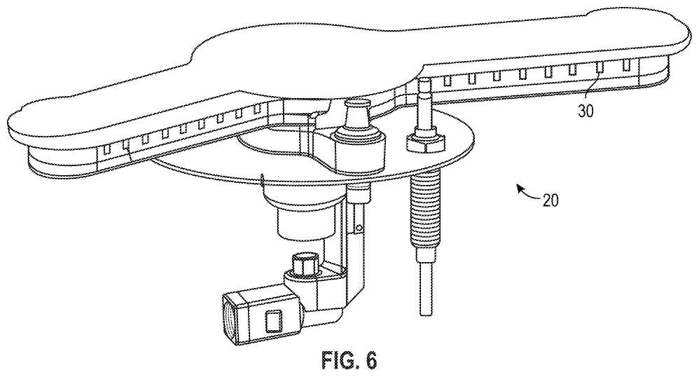

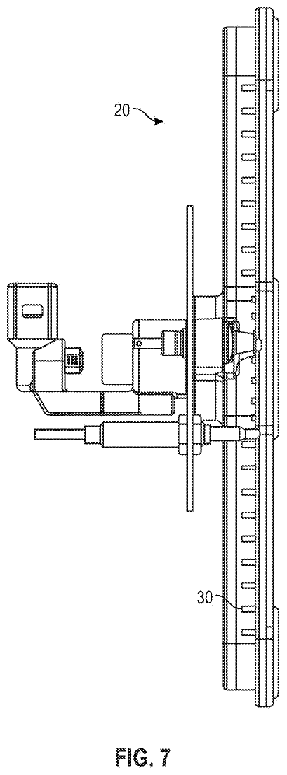

One embodiment of the second burner 20 is illustrated in FIGS. 5-7. The second gas burner 20 may include a plurality of generally horizontally directed flame openings 30, which flame openings may produce a generally horizontally directed flame. The generally horizontally directed flame openings 30 may be disposed at a height relative to the passing hamburger patties 11, such that the flames emanating from the horizontally directed flame openings 30 of the second gas burner 20 may be directed towards the passing hamburger patties 11, across the topside of the passing hamburger patties 11, to cook the passing hamburger patties 11 from the top side.

It is to be understood that this disclosure is not intended to limit the invention to any particular form described herein, but to the contrary, the invention is intended to include all modifications, alternatives and equivalents falling within the spirit and scope of the invention.

We claim:

1. A gas burner for a food cooking appliance, the food cooking appliance adapted to cook an underside of a food product, the burner comprising:
a plurality of circumferentially spaced flame openings;
a radiant disposed above and proximate to the spaced flame openings;
wherein heat generated by flames emanating from the spaced flame openings heats the radiant, causing the radiant to radiate heat, to increase the overall heat generated by the burner.

2. The gas burner of claim 1, wherein the radiant is made of cast iron.

3. The gas burner of claim 2, wherein the cast iron is GG18 grade cast iron.

4. The gas burner of claim 2, wherein the burner generates heat of the order of 350° C.

5. The gas burner of claim 1, wherein the food product is a hamburger patty.

6. A food cooking appliance for cooking a food product disposed on a substrate, the food cooking appliance comprising:
a gas burner disposed below the substrate, the gas burner including a plurality of circumferentially spaced flame openings and a radiant disposed above and proximate to the spaced flame openings;
wherein heat generated by flames emanating from the spaced flame openings heats the radiant, causing the radiant to radiate heat, to increase the overall heat transferred to the substrate by the burner to cook the underside of the food product.

7. The food cooking appliance of claim 6, wherein the radiant is made of cast iron.

8. The food cooking appliance of claim 7, wherein the cast iron is GG18 grade cast iron.

9. The food cooking appliance of claim 6, wherein the burner generates heat of the order of 350° C.

10. The food cooking appliance of claim 1, wherein the food product is a hamburger patty.

11. The food cooking appliance of claim 6, wherein the substrate is a rotary platter.

12. The food cooking appliance of claim 6, further including a second gas burner adapted to cook a topside of the food product, the second gas burner comprising a plurality of generally horizontally directed flame openings adapted to generate a generally horizontally oriented flame, wherein the gas burner is positioned such that the generally horizontally oriented flame is directed across the topside of the food product disposed on the substrate.

13. The food cooking apparatus of claim 11, wherein the radiant is made of cast iron.

14. The food cooking appliance of claim 12, wherein the cast iron is GG18 grade cast iron.

15. The food cooking appliance of claim 11, wherein the first burner generates heat of the order of 350° C.

16. The food cooking appliance of claim 12, wherein the food product is a hamburger patty.

17. The food cooking appliance of claim 12, wherein the substrate is a rotary platter.
